(19) United States
(12) Patent Application Publication
(10) Pub. No.: US 2026/0330765 A1
(43) Pub. Date: Oct. 22, 2026

(54) IMAGE PROCESSING USING GAUSSIAN SPLAT REPRESENTATIONS

(71) Applicant: QUALCOMM Incorporated, San Diego, CA (US)

(72) Inventors: Sandesh GHIMIRE, San Diego, CA (US); Meng-Lin WU, San Diego, CA (US); Yinhao ZHU, La Jolla, CA (US); Baekdu CHOI, San Diego, CA (US); Hong CAI, San Diego, CA (US)

(21) Appl. No.: 19/183,329

(22) Filed: Apr. 18, 2025

(51) Int. Cl. G06T 17/20

(52) U.S. Cl. CPC G06T 17/20

(57) ABSTRACT

Systems and techniques are described herein for image processing. For example, a computing device can receive a first image embedding of an environment and a requested viewing angle; process, using a machine learning system, the first image embedding and the requested viewing angle to generate a three-dimensional (3D) Gaussian splat representation of the first image embedding; and process the 3D Gaussian splat representation to generate a second image embedding of the environment represented in the first image embedding from the requested viewing angle.

### FIELD

The present disclosure generally relates to image processing (e.g., editing images, videos, and generating 3D renderings of the images). For example, aspects of the present disclosure relate to systems and techniques for image processing using Gaussian splat representations.

### BACKGROUND

Traditional image processing techniques have difficulty determining three-dimensional (3D) consistency of objects represented in the image. For example, traditional image processing techniques are unable to accurately predict how objects represented in an image may look from different viewing angles. The inaccuracies of traditional image processing techniques in determining 3D consistency of objects can make inpainting of images with adjusted fields of views (e.g., editing an image to adjust an angle of object and inpainting the environment exposed from the adjusted angle of the object) to be a difficult task. For example, traditional image processing techniques used to adjust an angle of an object represented in an image, can introduce occlusions and distortions into image representation of the object and the environment.

In some examples, traditional image processing techniques can use 3D scene reconstruction algorithms using multiple images from different angles of the scene to reconstruct a 3D scene. However, 3D scene reconstruction algorithms are generally computationally intensive and require dense sets of images from diverse angles. The requirement for dense sets of images limits the usability traditional 3D scene reconstruction algorithms in applications where a user generally would not take a dense set of images. Further, 3D scene reconstruction algorithms are often not generative, and are unable to inpaint.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In some aspects, an apparatus for image processing is provided. The apparatus includes at least one memory and at least one processor coupled to the at least one memory and configured to: receive a first image embedding of an environment and a requested viewing angle; process, using a machine learning system, the first image embedding and the requested viewing angle to generate a three-dimensional (3D) Gaussian splat representation of the first image embedding; and process the 3D Gaussian splat representation to generate a second image embedding of the environment represented in the first image embedding from the requested viewing angle.

In some aspects, a method for image processing is provided. The method includes: receiving a first image embedding of an environment and a requested viewing angle; processing, using a machine learning system, the first image embedding and the requested viewing angle to generate a three-dimensional (3D) Gaussian splat representation of the first image embedding; and processing the 3D Gaussian splat representation to generate a second image embedding of the environment represented in the first image embedding from the requested viewing angle.

In some aspects, a non-transitory computer-readable medium is provided having stored thereon instructions that, when executed by at least one processor, cause the at least one processor to: receive a first image embedding of an environment and a requested viewing angle; process, using a machine learning system, the first image embedding and the requested viewing angle to generate a three-dimensional (3D) Gaussian splat representation of the first image embedding; and process, using a renderer, the 3D Gaussian splat representation to generate a second image embedding of the environment represented in the first image embedding from the requested viewing angle.

In some aspects, an apparatus for image processing is provided. The apparatus includes: means for receiving a first image embedding of an environment and a requested viewing angle; means for processing, using a machine learning system, the first image embedding and the requested viewing angle to generate a three-dimensional (3D) Gaussian splat representation of the first image embedding; and means for processing the 3D Gaussian splat representation to generate a second image embedding of the environment represented in the first image embedding from the requested viewing angle.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 illustrates an example implementation of a system-on-a-chip (SoC), in accordance with aspects of the present disclosure.

FIG. 2 illustrates an example machine learning system for Gaussian splat generation, in accordance with aspects of the present disclosure.

FIG. 3 illustrates another example machine learning system for Gaussian splat generation, in accordance with aspects of the present disclosure.

FIG. 4 illustrates an example of training a machine learning system for Gaussian splat generation, in accordance with aspects of the present disclosure.

FIG. 5 is a flow diagram illustrating an example process of image processing, in accordance with aspects of the present disclosure.

FIG. 6 is a block diagram illustrating an example neural network, in accordance with aspects of the present disclosure.

FIG. 7 is a block diagram illustrating an example convolutional neural network, in accordance with aspects of the present disclosure.

FIG. 8 is a block diagram of an example transformer in accordance with aspects of the disclosure.

FIG. 9 is a block diagram illustrating example computing device architecture of an example computing device which can implement the various techniques described herein.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the example embodiments will provide those skilled in the art with an enabling description for implementing an example embodiment. It should be understood that various changes may be made in the function and arrangement of elements without departing from the spirit and scope of the application as set forth in the appended claims.

As previously mentioned, traditional image processing techniques have difficulty in considering three-dimensional (3D) consistency of objects represented in the image. For example, traditional image processing techniques are unable to accurately predict how objects represented in an image may look from different angles. The inaccuracies of traditional image processing techniques in considering 3D consistency of objects can make inpainting of images with adjusted fields of views (e.g., editing an image to adjust an angle of object and inpainting the environment exposed from the adjusted angle of the object) difficult. For example, traditional image processing techniques used to adjust an angle of an object, such as the angle of the head of a person in an image, can introduce occlusions, distortions, and inconsistencies of the head of the person and the environment around the person. In some examples, traditional image processing techniques can use 3D scene reconstruction algorithms using multiple images from different angles of the scene to reconstruct a 3D scene represented in the image. However, 3D scene reconstruction algorithms are generally computationally intensive and require dense sets of images from diverse angles. The requirement for dense sets of images limits the usability traditional 3D scene reconstruction algorithms in applications where a user generally would not take a dense set of images. Further, 3D scene reconstruction algorithms are often not generative, and are unable to inpaint or generate.

Traditional 3D scene reconstruction algorithms, and other 3D modeling techniques, can be used generate 3D model representations of images. Various 3D modeling techniques include voxel based reconstruction of a 3D scene. Another 3D modeling technique can include mesh representation of environments. Mesh representations can use polygons (e.g., including edges, vertices, and faces of the polygons) to approximate the geometry of objects in the real-world. Voxel and mesh representations can be computationally intensive models in part due to the number of different points and shapes needed to represent curved surfaces. Gaussian splats (e.g., 3D Gaussian splats) provide an alternative 3D modeling technique to generating 3D representations of objects and environments which can be used to conserve computing resources in 3D modeling. A Gaussian splat of an object is a point-based 3D representation of the object constructing a 3D representation of the object using ellipsoids. Gaussian splats can include ellipsoids of varying shapes, sizes, and orientations to construct a 3D representation of the object. Each ellipsoid can include various parameters including coordinate locations (e.g., x, y, and z-coordinates), angle, size, shape (radii, semi-axes lengths), orientation, etc. In further examples, the ellipsoids of Gaussian splats can include parameters representing characteristics of an environment or object which the Gaussian splats represent. For example, the ellipsoids can include parameters such as color, texture, opacity, brightness, etc.

Current systems for image processing are unable to accurately perform inpainting operations for objects in images when adjusting a viewing angle of the object. An example can include editing an image of a person facing a camera. Many image processing systems and techniques are unable to accurately edit the image to adjust the angle of the person facing the camera. For example, because adjusting the angle of the person exposes portions of the person not captured in the image and portions of the environment not captured in the image, many image processing techniques are unable to provide accurate predictions of what should be positioned in the exposed portions of the person and environment. One example in which traditional image processing techniques are inaccurate is in providing inpainting of the exposed portions of the person and the environment which are consistent with the geometry (e.g., 3D geometry) of the person and the environment (e.g., the 3D shape of the person, shape, or environment). Generative imaging techniques (e.g., using generative machine learning systems) can be used to predict how the image or environment can appear at the exposed portions.

The inaccuracies of traditional image processing techniques in providing inpainting of exposed portions of an image (or of the objects or environments represented in the image) resulting from shifting the position or orientation of objects in the image can be identified as distortions in an image such as a visual stretching of an object inaccurate to the 3D shape of the object, clipping of backgrounds causing inaccurate borders between objects, occlusions to portions of the image, etc. The inaccuracies of traditional image processing techniques are also visible in examples where a machine learning system (e.g., a machine learning model) is used to perform outpainting techniques using requested viewing angles, shifting objects in an image. Similar to the issues with traditional image processing techniques in providing inpainting, traditional image processing techniques for outpainting and requested viewing angles (e.g., changes in viewing angles of the image) are oftentimes inaccurate because the image processing techniques are unable to determine the 3D geometry of the objects, and the environment represented in an image. Systems and techniques which can provide 3D context to images can be used to improve the accuracy of inpainting (and other image processing techniques such as outpainting, requested viewing angles, panoramic imaging, etc.) and other image processing and editing techniques which expose portions of an object or environment not captured in the image by providing predictions of the 3D geometry of the objects and the environment represented in the image.

Systems, apparatuses, electronic devices, methods (also referred to as processes), and computer-readable media (collectively referred to herein as “systems and techniques”) are described herein for image processing. The systems and techniques include using a machine learning system. The machine learning system can include one or more machine learning models, such as U-Net convolutional neural network (CNN) architecture. In some examples, the CNN can be a diffusion machine learning model. In such an example, the diffusion machine learning model can be a conditional diffusion machine learning model. For example, the conditions of the diffusion machine learning model can include images, user prompts (e.g., user requests), and 3D model representations (such as partial 3D models including Gaussian 3D splat representations of an object).

The machine learning system can receive the one or more images and the user prompt from a user as inputs. In further examples, the machine learning system can receive a noise distribution, such as a three-dimensional (3D) Gaussian splat noise distribution, as input or can generate the noise distribution. The machine learning system can process the one or more images (including videos), the user prompt, and the noise distribution (using the conditional diffusion machine learning model) to generate a 3D model representation of an object represented in the one or more images. In some examples, the 3D model representation can be used by the machine learning system, or another machine learning system, service, or algorithm to generate an image representation of the object based on the user prompt. For example, the output of the machine learning system can be 3D Gaussian splat representation of the object. In such an example, the 3D Gaussian splat representation can be a sparse representation of latent features of the object based on the user prompt.

In some examples, the machine learning system can generate embedding representations of the images. For example, the machine learning system can process an image to generate an embedding representation of the image. In further examples, the machine learning system can receive a plurality of images and generate a plurality of embedding representations of the images. In such an example, a user can provide multiple images of an object in an environment from multiple viewing angles. In other examples, the machine learning system can receive 3D model or partial 3D model of the objects as inputs. The machine learning system can process the 3D model to generate an embedding representation of the 3D model. In such an example, the machine learning system can process the 3D model to predict gaps in the 3D model. In a further example, the input to the machine learning system (such as a U-Net architecture machine learning system) can include noise and conditional information (e.g., text, one or more images, a partial 3D model). The machine learning system can be trained to generate a 3D Gaussian splat representation which can be used to render images from various viewing angles.

The user prompt can be a text request to edit the image. For example, the user prompt can include a request to adjust the viewpoint of the image (e.g., a requested viewing angle). In such an example, the requested viewing angle can be a text request such generate the image as if the camera generating the image was positioned at a 30 degree angle to the left. In other examples, the user can interact with the image on a user interface of an application to adjust a viewpoint of objects represented in the image. In further examples, the requested viewing angle can be represented as an embedding representation of a pixel-by-pixel position and orientation of the requested viewing angle of an object represented in the image.

In such an example, the viewing angle can be an embedding representation indicating ray directions of the requested viewing angle which an image or 3D model representation of an object represented in the image is to be generated. For example, the 3D Gaussian splat representation (also referred to as the 3D Gaussian splat) generated by the machine learning system can be a 3D model representation of an object and an environment represented in the processed image. The viewing angle can include a position (within the environment represented in the image) and an orientation (e.g., the direction and angle representing a requested perspective of the environment and object). The machine learning model can generate a 3D Gaussian splat based on the requested viewing angle. For example, the image processed by the machine learning system can be an image of the front of a chair and the requested viewing angle can include a request to generate an image view the back of the chair at a downward angle. In such an example, the 3D Gaussian splat can be generated. The 3D Gaussian splat can be projected into the requested viewing angle and the machine learning system can render an image based on the 3D Gaussian splat from the requested viewing angle.

The machine learning system can receive a noise distribution as input. For example, noise distribution can be a random noise distribution of Gaussian splats. For example, the noise distribution can be a 3D noise distribution (e.g., a 3D Gaussian splat noise distribution) including a plurality of ellipsoids of random shapes, sizes, orientations, positions, etc. In such an example, the machine learning system can include a diffusion machine learning model to perform reverse denoising of the noise distribution to generate the 3D Gaussian splat representation. The 3D Gaussian splat representation can be a plurality of 3D ellipsoids arranged in a predicted 3D shape of the object. In some examples, the machine learning system can output a sparse 3D Gaussian splat representation representing latent features of the object (and the environment in which the object is located) from the image. In such an example, the 3D Gaussian splat representation can be received by another machine learning system (or another machine learning model of the machine learning system) to generate an image based on the 3D Gaussian splat representation or a 3D model (e.g., a 3D mesh representation, or a 3D Gaussian splat representation of higher resolution than the sparse 3D Gaussian splat) of the object and the environment based on the 3D Gaussian splat representation.

In some examples, the machine learning system can process the 3D Gaussian splat representation using a decoder of the machine learning system to perform a task. For example, the task can be to generate an image of the 3D Gaussian splat representation. In such an example, the machine learning system can process the 3D Gaussian splat representation to generate an image embedding representation of the 3D Gaussian splat representation. In such an example, the image embedding representation can be used to generate an image. For example, the 3D Gaussian splat representation can represent a predicted 3D model of an object represented in a processed image at a requested viewing angle. The machine learning system can transform the 3D Gaussian splat representation to an image embedding which can be rendered as an image of the object at the requested viewing angle.

In some examples, the image embedding can be an image embedding of a plurality of images. In such an example, the image embedding can be an image embedding of a plurality of images from various viewing angles of an environment or object. For example, the image embedding can be an embedding representation of a first image from a first viewing perspective and a second image from a second viewing perspective.

In some examples, the machine learning system (or the conditional machine learning model of the machine learning system) can be trained using training data representing a 3D Gaussian splat representation of a training object (e.g., an object represented in image to use for training the machine learning system). For example, the training data can include a plurality of 3D Gaussian splat representations of a training object represented in a training image (or a training image embedding). In some examples, the machine learning system can generate the training data by iteratively adding 3D noise (e.g., additional 3D ellipsoids) to the 3D Gaussian splat representation and performing denoising of the 3D Gaussian splat representation.

The machine learning system can iteratively add noise to the 3D Gaussian splat representation represented as zₜ=αₜz₀+σₜ∈ where zₜ represents a 3D Gaussian splat representation including an amount of 3D noise based on t (e.g., time or iterations of added noise). For example, the machine learning system can iteratively add noise to an initial 3D Gaussian splat representation (e.g., a ground truth 3D Gaussian splat representation) represented as z₀. In such an example, the 3D Gaussian splat representations associated with a higher t value can be associated with a higher amount of 3D noise. In such an example, at and σₜ∈ can represent noise added to the ground truth 3D Gaussian splat representation to generate zₜ. In such an example, σₜ can represent a weighting factor (e.g., a scalar value) of the noise at a time t and ∈ is a noise vector. In one example, ∈ can include multiple random noise values arranged in a vector. In such an example, the ∈ The time information is handled by the σₜ which can have different values at different times t. The value of Ot can increases as time changes from t=0 towards t=1.

The systems and techniques can include using the machine learning system to process the 3D Gaussian splat representations including varying amounts of 3D noise and the training image (e.g., an image of the training object) to generate 3D Gaussian splat representations of the training image (e.g., a 3D Gaussian splat representation of the training object represented in the training image or training image embedding). The 3D Gaussian splat representations can be compared to the ground truth 3D Gaussian splat representation to determine a loss of the machine learning system. For example, the loss function of the machine learning system can be Loss=∥\hat{z}_{θ}(zₜ, t, y)−z₀∥² where y represents the training image. In some examples, the systems and techniques can include using a viewing angle as an input. In such an example, y can include the training image and the viewing angle of the training image (or user prompt including the viewing angle).

The systems and techniques can include adjusting parameters of the machine learning system based on the loss (e.g., to reduce the loss function). For example, the machine learning system can process conditions to the machine learning system (e.g., the training image and user prompt or embedding representations of the training image and user prompt) into a vector to modify parameters (such as mean and variance parameters) of a normalization layer of the machine learning system. In another example, the systems and techniques can include adjusting parameters of a cross-attention layer to calculate cross-attention values between an input vector and the conditions.

In one example, images and texts are converted into a vector which can modify a normalization layer of the machine learning system (e.g., Adaptive Norm(AdaN)). For example, the normalization layer of the machine learning system can be represented as AdaN(h, u)=u_s·Norm(h)+u_b. In such an example, u_s and u_b can be parameters represented as vectors. In such an example, u_s can be a scaling parameter which can multiply normalized form of features from previous layers of the machine learning system, represented as h. In a further example, u_b is a bias parameter and is added to u_s·Norm(h). In such an example, [u_s, u_b]=Vector_projection(y).

In some aspects, the systems and techniques can include rendering images from the 3D Gaussian splat representation. In some examples, the machine learning system can render the images. In other examples, an additional machine learning system, machine learning model, or rendering engine (e.g., a renderer) can be used to generate images or 3D model representations of an image using the 3D Gaussian splat representation.

In one example, the ellipsoids of the 3D Gaussian splat representations can include additional parameters (e.g., in addition to size, shape, orientation, position) associated with visual characteristics of an object represented by the ellipsoids, such as color. In such an example, color can be represented as a function of spherical harmonics coefficients (e.g., γᵢ) and viewing direction (e.g., d). In such an example, the colors of the 3D Gaussian splat representation can be determined based on blending the color of ellipsoids of the 3D Gaussian splat representation. In such an example, groups of ellipsoids which are located along a ray of a viewing angle (e.g., the requested viewing angle) can be sorted based on depth (e.g., determined distances between ellipsoids and groups of the ellipsoids within a 3D space).

The pixel values of pixels of an image at position u can be represented by equation

$${C}^{m} ( u ) = {\sum }_{i = 1}^{N} {c}_{i} {O}_{i}^{m} ( u ) {\prod }_{j = 1}^{i - 1} ( 1 - {O}_{i}^{m} ( u ) ) where {O}_{i}^{m} = {α}_{i} {G}_{i}^{m} ( u ) .$$

The equation can take into account the Gaussian splats that are in a ray (e.g., a direction or line) from position u in a viewing direction. N can represent the number Gaussian splats in the ray (e.g., the number of Gaussian splats along the direction or line). The color of the Gaussian splats, cᵢ, can be added (e.g., cᵢ weighted or multiplied based on opacity of the Gaussian splat represented by

$${O}_{i}^{m}$$

and multiplied by the transparency of the Gaussian splats along the ray before the Gaussian splat) to determine the color or pixel value C^{m}(u). In such an example,

$${G}_{i}^{m}$$

can be represented as

$${G}_{i}^{m} = exp [ - \frac{1}{2} {( u - {μ}_{i}^{m} )}^{T} {( {\sum }_{i}^{m} )}^{- 1} ( u - {μ}_{i}^{m} ) ] .$$

In such an example,

$${O}_{i}^{m}$$

can represent the transparency of the ellipsoids (e.g., the opacity). In such an example, the opacity can be a product of a direction independent value αᵢ and

$${G}_{i}^{m} ,$$

which can depend on the angle between position and orientation of ellipsoids of the 3D Gaussian splat representation.

Opacity can also depend on an orientation of an image plane (e.g., a viewing angle) and an orientation of the Gaussian blob.

$${G}_{i}^{m}$$

can account for the orientations

$$( e . g . , {G}_{i}^{m} = exp [ - \frac{1}{2} {( u - {μ}_{i}^{m} )}^{T} {( {\sum }_{i}^{m} )}^{- 1} ( u - {μ}_{i}^{m} ) ] ) .$$

In such an example

$${μ}_{i}^{m}$$

can be the center of a plurality of Gaussian splats. In a further example,

$$u - {μ}_{i}^{m}$$

can represent in 3D vector form a distance a Gaussian splat is from the center of the plurality of Gaussian splats.

Various aspects of the present disclosure will be described with respect to the figures.

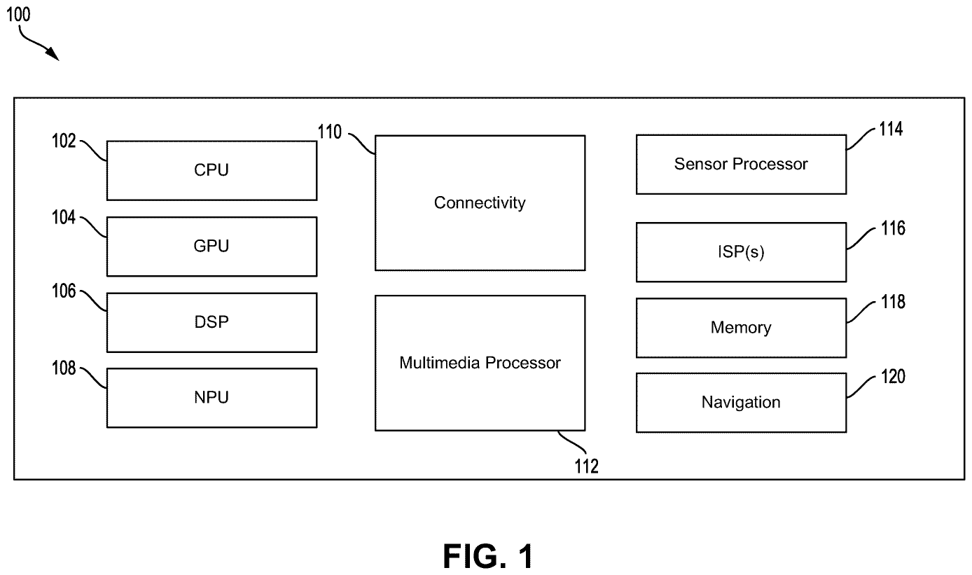

FIG. 1 illustrates an example implementation of a system-on-a-chip (SOC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize audio signals. In one implementation, the NPU is implemented in the CPU 102, DSP 106, and/or GPU 104. The SOC 100 may also include one or more sensors 114 such as but not limited to one or more microphones, image signal processors (ISPs) 110, and/or storage 120.

The SOC 100 may be based on an ARM instruction set. In an aspect of the present disclosure, the instructions loaded into the CPU 102 may comprise code to search for a stored multiplication result in a lookup table (LUT) corresponding to a multiplication product of an input value and a filter weight. The instructions loaded into the CPU 102 may also comprise code to disable a multiplier during a multiplication operation of the multiplication product when a lookup table hit of the multiplication product is detected. In addition, the instructions loaded into the CPU 102 may comprise code to store a computed multiplication product of the input value and the filter weight when a lookup table miss of the multiplication product is detected.

SOC 100 and/or components thereof may be configured generate explanations for actions performed (e.g., to be performed, predicted to be performed, etc.) by a machine learning model. The explanations can be one or more of a text-based description, set of instructions to perform a sub-task or task, etc. according to aspects of the present disclosure discussed herein. The SOC can be used to operate various machine learning models for image processing, text processing, feature extraction, signal controls generation, etc. For example, SOC 100 and/or components thereof may be configured to perform processing techniques such as but not limited to: segment shifting, shuffle correlation, gain shifting, segment masking, and additional processing techniques. SOC 100 can be part of a computing device or multiple computing devices. In some examples, SOC 100 can be part of an electronic device (or devices) such as an audio recording device, camera system (e.g., a digital camera, an IP camera, a video camera, a security camera, etc.), a telephone system (e.g., a smartphone, a cellular telephone, a conferencing system, etc.), a desktop computer, an XR device (e.g., a head-mounted display, etc.), a smart wearable device (e.g., a smart watch, smart glasses, etc.), a laptop or notebook computer, a tablet computer, a set-top box, a television, a display device, a system-on-chip (SoC), a digital media player, a gaming console, a video streaming device, a server, a drone, a computer in a car, an Internet-of-Things (IoT) device, or any other suitable electronic device(s).

In some implementations, the CPU 102, the GPU 104, the DSP 106, the NPU 108, the connectivity block 110, the multimedia processor 112, the one or more sensors 114, the ISPs 116, the memory block 118 and/or the storage 120 can be part of the same computing device. For example, in some cases, the CPU 102, the GPU 104, the DSP 106, the NPU 108, the connectivity block 110, the multimedia processor 112, the one or more sensors 114, the ISPs 116, the memory block 118 and/or the storage 120 can be integrated into a smartphone, laptop, tablet computer, smart wearable device, video gaming system, server, and/or any other computing device. In other implementations, the CPU 102, the GPU 104, the DSP 106, the NPU 108, the connectivity block 110, the multimedia processor 112, the one or more sensors 114, the ISPs 116, the memory block 118 and/or the storage 120 can be part of two or more separate computing devices.

Machine learning (ML) can be considered a subset of artificial intelligence (AI). ML systems can include algorithms and statistical models that computer systems can use to perform various tasks by relying on patterns and inference, without the use of explicit instructions. An example of a ML system is a neural network (also referred to as an artificial neural network), which may include an interconnected group of artificial neurons (e.g., neuron models). Neural networks may be used for various applications and/or devices, such as image and/or video coding, image analysis and/or computer vision applications, Internet Protocol (IP) cameras, Internet of Things (IoT) devices, autonomous vehicles, service robots, among others.

Individual nodes in a neural network may emulate biological neurons by taking input data and performing simple operations on the data. The results of the simple operations performed on the input data are selectively passed on to other neurons. Weight values are associated with each vector and node in the network, and these values constrain how input data is related to output data. For example, the input data of each node may be multiplied by a corresponding weight value, and the products may be summed. The sum of the products may be adjusted by an optional bias, and an activation function may be applied to the result, yielding the node's output signal or “output activation” (sometimes referred to as a feature map or an activation map). The weight values may initially be determined by an iterative flow of training data through the network (e.g., weight values are established during a training phase in which the network learns how to identify particular classes by their typical input data characteristics).

Different types of neural networks exist, such as convolutional neural networks (CNNs), recurrent neural networks (RNNs), generative adversarial networks (GANs), multilayer perceptron (MLP) neural networks, transformer neural networks, among others. For instance, convolutional neural networks (CNNs) are a type of feed-forward artificial neural network. Convolutional neural networks may include collections of artificial neurons that each have a receptive field (e.g., a spatially localized region of an input space) and that collectively tile an input space. RNNs work on the principle of saving the output of a layer and feeding this output back to the input to help in predicting an outcome of the layer. A GAN is a form of generative neural network that can learn patterns in input data so that the neural network model can generate new synthetic outputs that reasonably could have been from the original dataset. A GAN can include two neural networks that operate together, including a generative neural network that generates a synthesized output and a discriminative neural network that evaluates the output for authenticity. In MLP neural networks, data may be fed into an input layer, and one or more hidden layers provide levels of abstraction to the data. Predictions may then be made on an output layer based on the abstracted data.

For example, the use of recurrent connections and/or temporal information in a machine learning model for audio processing, such as denoising of audio signals, can be used to preserve low-frequency audio signals in audio signals with wind noise, to achieve higher quality audio signals. Various recurrent architectures (e.g., RNNs) that include one or more recurrent cells among the feed-forward layers of the network can be used to perform audio processing operations to generate processed output audio signals having a relatively high quality. For example, recurrent cells can be implemented using a vanilla-RNN architecture, a Conv-GRU (Gated Recurrent Unit) architecture, a Conv-LSTM (Long Short-Term Memory) architectures, among various others.

Deep learning (DL) is an example of a machine learning technique and can be considered a subset of ML. Many DL approaches are based on a neural network, such as an RNN or a CNN, and utilize multiple layers. The use of multiple layers in deep neural networks can permit progressively higher-level features to be extracted from a given input of raw data. For example, the output of a first layer of artificial neurons becomes an input to a second layer of artificial neurons, the output of a second layer of artificial neurons becomes an input to a third layer of artificial neurons, and so on. Layers that are located between the input and output of the overall deep neural network are often referred to as hidden layers. The hidden layers learn (e.g., are trained) to transform an intermediate input from a preceding layer into a slightly more abstract and composite representation that can be provided to a subsequent layer, until a final or desired representation is obtained as the final output of the deep neural network.

As noted above, a neural network is an example of a machine learning system, and can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases. Deep learning architectures may perform especially well when applied to problems that have a natural hierarchical structure. For example, the classification of audio can benefit from first learning to recognize individual spoken words, instruments in music, etc. These features may be combined at higher layers in different ways to recognize sounds such as speech, instruments, wind noise, etc.

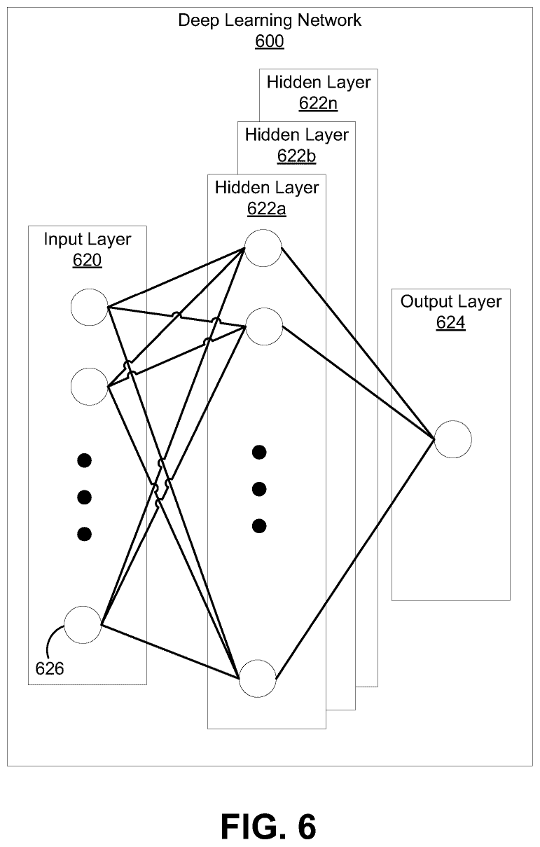

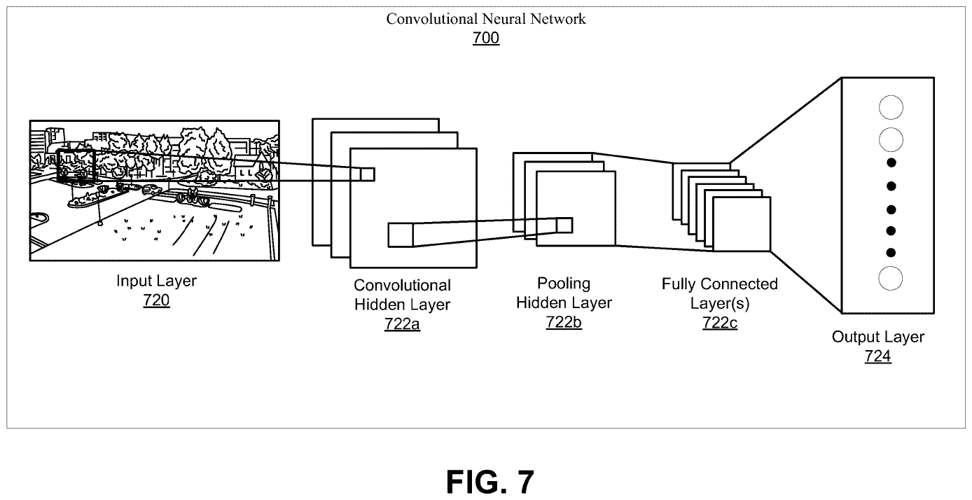

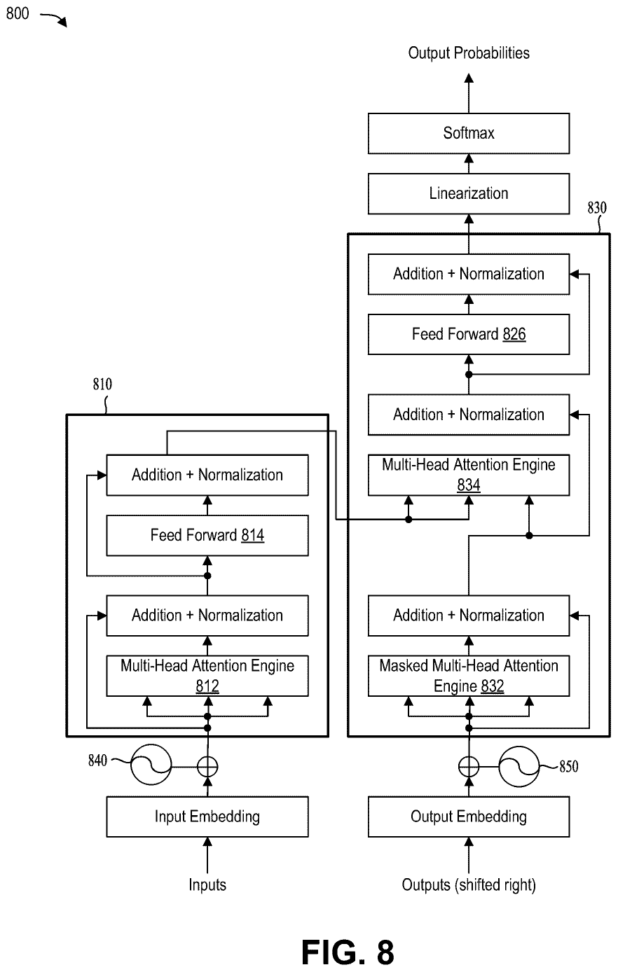

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input. Further description of machine learning model architecture is provided in the description of FIG. 6, FIG. 7, and FIG. 8.

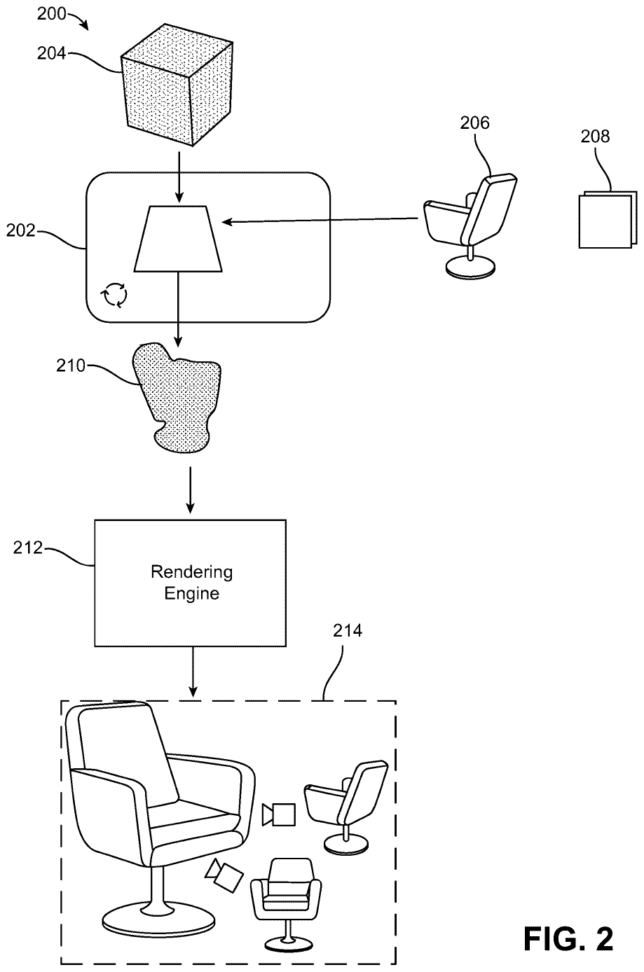

The SOC 100 of FIG. 1 can be used to perform the various systems and techniques described in the descriptions of FIG. 2-FIG. 5. For example, the SOC 100 can be used to perform operations of the machine learning system 200 of FIG. 2 including 3D Gaussian splat generation and random 3D noise distribution (e.g., three-dimensional (3D) Gaussian splat noise distribution) generation.

FIG. 2 is a block diagram illustrating an example machine learning system 200 for image processing using 3D Gaussian splat generation. The machine learning system 200 includes a machine learning model 202 and a rendering engine 212 (also referred to as a renderer). In some examples, the rendering engine 212 can be part of the machine learning model 202. In other examples, the rendering engine 212 can be an additional machine learning model or component of a machine learning model such as a decoder.

In some examples, machine learning model 202 can be a conditional diffusion machine learning model (e.g., a diffusion machine learning model which can receive conditional inputs such as an image 206, a viewing angle information 208 (e.g., a requested viewing angle). In some examples, the viewing angle information 208 can be determined based on a user input or user prompt. For example, the viewing angle information 208 can be determined based on a user input to a user interface, such as based on a text based description of the viewing angle. In another example, the user input can be a swipe of a finger on a touchscreen, adjustment of a viewing angle using a mouse and keyboard, etc.

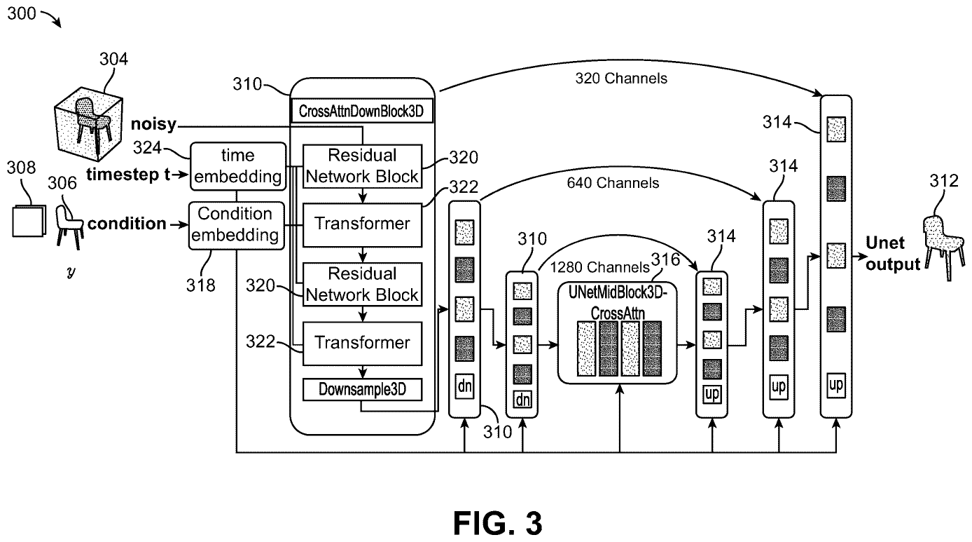

In further examples, the machine learning model 202 can use neural architecture. For example, the machine learning model 202 can be a convolutional neural network (CNN) using U-Net architecture. For example, the U-Net architecture can be a 3D U-Net. Further description of the architecture is provided in the description of FIG. 3. The machine learning model 202 can use the conditional inputs (e.g., the image 206 and the viewing angle information 208) and a 3D noise distribution 204 to generate 3D Gaussian splat representation 210. In some examples the conditional inputs can include a user prompt. The 3D Gaussian splat representation 210 can be processed using the rendering engine 212 to generate an image based on the conditional inputs (e.g., using the viewing angle information 208 and the image 206).

The machine learning model 202 can receive as conditional inputs the image 206 and a viewing angle information 208. In some examples, the image 206 can be an embedding representation of an image. For example, the embedding representation can be a matrix of pixel values representing the image. In further examples, the image can depict an object within an environment. For example, the image 206 depicts a chair facing away from a camera. In some examples, the machine learning model 202 can receive a plurality of images. For example, the plurality of images can depict an object and an environment in which the object is located from various positions and orientations (e.g., various positions and orientations of a camera generating the plurality of images). In such an example, the plurality of images can be represented as a plurality of embedding representations. In further examples, the plurality of images can be represented as a combined embedding representation of the plurality of images.

In another example, the machine learning model 202 can receive a video of an object. In such an example, individual frames of the video can be processed by the machine learning model 202. In further examples, the video (or the images), can be processed using a pre-processing engine to generate embedding representations of the video.

In further examples, the machine learning model 202 can receive a 3D model representation of an object in an environment. For example, the machine learning model 202 can process partial 3D model representations of an object (e.g., a 3D model representation including gaps such as a 3D model representation for portions of an object). For example, a partial 3D model representation can include a 3D model such as a mesh, voxel representation, or 3D Gaussian splat representation of an object which is incomplete (e.g., a 3D model of a portion of an object and portion of an environment). In some examples, the machine learning model 202 (or a pre-processing engine) can generate an embedding representation of the partial 3D model representation. The machine learning model 202 can process the embedding representation to generate a 3D Gaussian splat representation 210 of the object represented in the partial 3D model representation of the object (or the image, plurality of images, and video).

In some examples, the conditional information can include a user prompt. In such an example, the user prompt can be a text prompt to the machine learning model 202 (or machine learning system 200) such as a text-based request from a user to generate an image of an object represented in the image 206 from a different viewing angle (e.g., a requested viewing angle). For example, the user prompt can include a request such as “generate an image of the chair face the camera.” In some examples, a pre-processing engine (or the machine learning model 202) can process the request to generate an embedding representation of the request.

For example, the viewing angle information 208 (including the requested viewing angle) can be represented as an embedding representation of a pixel-by-pixel position and orientation of the requested viewing angle of an object represented in the image. In such an example, an embedding representation of the requested viewing angle of the viewing can be the same resolution (e.g., same dimensions) of the image (or embedding representation of the image). Embedding values of the embedding representation of the requested viewing angle can correspond to pixels of the image. In some examples, the embedding values can indicate ray directions of the requested viewing angle. In such an example, the requested viewing angle can include a position (e.g., a determined position of the camera within the environment to capture an image from the requested viewing angle) and an orientation (e.g., the direction and angle representing the requested perspective of the environment and object).

In such an example, the machine learning model 202 can generate a 3D Gaussian splat representation 210 based on the requested viewing angle of the viewing angle information 208, the image 206, and the 3D noise distribution 204 (e.g., e.g., three-dimensional (3D) Gaussian splat noise distribution). For example, the image processed by the machine learning system can be an image of the front of a chair and the requested viewing angle can include a request to view the back of the chair at a downward angle. In such an example, the machine learning system can be projected based on the requested viewing angle. The further examples, the machine learning system can generate or render an image based on the requested viewing angle or the viewing angle information 208.

The machine learning model 202 can receive the 3D noise distribution 204. In some examples, the machine learning model 202 can generate the 3D noise distribution 204. The 3D noise distribution 204 can be a random 3D noise distribution of 3D Gaussian splats (e.g., ellipsoids). For example, the 3D noise distribution can be a random 3D noise distribution of ellipsoids of varying position, shape, size, orientation, etc.

The machine learning model 202 can receive the 3D noise distribution 204 and the conditional inputs (e.g., the image 206 and the viewing angle information 208) to generate a 3D Gaussian splat representation of an object (and the environment in which the object is located). In such an example, the machine learning model 202 (or the machine learning system 200) can perform reverse denoising of the noise distribution to generate the 3D Gaussian splat representation 210 of the object based on the viewing angle information 208 (e.g., a requested viewing angle of the viewing angle information 208).

In some examples, the 3D Gaussian splat representation 210 can be a plurality of 3D ellipsoids arranged in a predicted 3D shape of the object represented from the requested viewing angle. In further examples, the 3D Gaussian splat representation 210 can be a sparse 3D Gaussian splat representation representing latent features of objects (and the environment in which the objects are located) represented in the image 206. For example, the sparse 3D Gaussian splat representation can represent an outline of features of the objects (e.g., shape, size, orientation) represented in the image 206. The machine learning system 200 can use a rendering engine 212 to render the sparse 3D Gaussian splat as an image, or a 3D model (e.g., a 3D mesh representation, a higher resolution 3D Gaussian splat representation, etc.).

In some examples, the rendering engine 212 can be a machine learning model, such as a generative machine learning model. In some examples, the rendering engine 212 can be part of the machine learning model 202, such as a decoder of the machine learning model 202 or a decoder of the machine learning system 200. The rendering engine 212 can render the 3D Gaussian splat as an image or a 3D model as illustrated by output 214. For example, the rendering engine 212 can be configured to generate images as output 214. In such an example, the rendering engine can use various inpainting techniques and processing techniques of a sparse 3D Gaussian splat (e.g., the 3D Gaussian splat representation 210) to generate an image. For example, the 3D Gaussian splat representation 210 is a Gaussian splat representation of objects represented in image 206 based on the viewing angle information 208, and includes features (e.g., characteristics) of the objects such as shape, size, position in a 3D environment, orientation in the 3D environment, etc. represented by the arrangement of ellipsoids in the 3D Gaussian splat representation. The rendering engine 212 can process the ellipsoids of the 3D Gaussian splat representation to render the 3D Gaussian splat representation in color, with textures, and other visual characteristics as an image based on the viewing angle information 208.

For example, the ellipsoids of the 3D Gaussian splat representation 210 can include visual characteristics of the object, which the rendering engine 212 can use to generate an image or 3D model representation of the object. The rendering engine 212 can process the ellipsoids of the 3D Gaussian splat representation 210 to generate image representations of objects and the environment represented in the 3D Gaussian splat representation 210. For example, the rendering engine 212 can render an image by finding the pixel value at each pixel position of a two-dimensional (2D) grid (e.g., of the image).

FIG. 3 is a block diagram illustrating example machine learning architecture of a machine learning system 300 for generating 3D Gaussian splat representations of objects represented in an image (e.g., image 306). In some examples, the machine learning system 300 can be the machine learning system 200 of FIG. 2. For example, the machine learning system 200 can use U-Net architecture, such as the U-Net architecture illustrated in FIG. 3. By way of non-limiting example, FIG. 3 illustrates the machine learning system 300 during training.

FIG. 3 illustrates cross-attention downsampling blocks 310 representing an encoder (e.g., a downsampling path) of the machine learning system 300 and cross-attention up-sampling block 314 representing a decoder (e.g., an up-sampling path) of the machine learning system 300. By way of a non-limiting example, a first cross-attention block can include 320 channels. The outputs of the cross-attention downsampling blocks 310 can be received as inputs a subsequent cross-attention block which can have double in channels for each subsequent cross-attention block. The machine learning system 300 includes a middle cross-attention block 316 positioned between the encoder and the decoder. The middle cross-attention block 316 can process outputs of the cross-attention downsampling blocks 310 to refine a feature map representation of the 3D Gaussian splat representation to be generated (e.g., the 3D Gaussian splat representation 312) and output the refined feature map representation to the decoder for generation of the 3D Gaussian splat representation 312 from the refined feature map.

The cross-attention downsampling blocks 310 and the cross-attention blocks 314 can include various layers. For example, the cross-attention downsampling blocks 310 and the cross-attention up-sampling block 314 can include one or more residual network blocks 320 such as ResnetBlock3D blocks. The residual network blocks 320 can include various layers to perform 3D convolutions (e.g., to extract spatial features from the inputs to the cross-attention downsampling blocks 310 and the cross-attention up-sampling block 314. The residual network blocks can include normalization layers, activation layers, and skip connections between the cross-attention downsampling blocks 310 and the cross-attention up-sampling block 314.

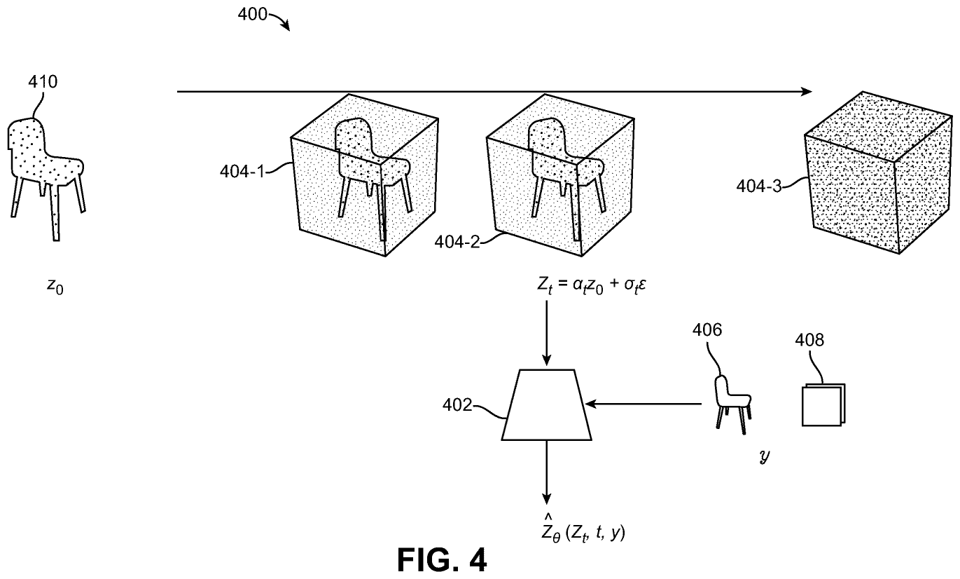

The cross-attention downsampling blocks 310 and the cross-attention up-sampling block 314 can include blocks incorporating transformer architecture 322, such as Transformer3DModel blocks. In some examples, the condition embedding 318 can be provided to a cross-attention layer of the transformer architecture 322. In further examples, the machine learning system 300 can adjust parameters of cross-attention layers of the transformer architecture 322 based on a loss function, as further described in the description of FIG. 4.

The cross-attention downsampling blocks 310 can receive as input an image 306, viewing angle information 308 (e.g., a user prompt or user input associated with a requested viewing angle), and a 3D noise distribution 304. The cross-attention downsampling blocks 310 can receive the inputs at various layers of the cross-attention downsampling blocks 310. For example, the image 306 and the viewing angle information 308 can be represented as a condition embedding 318. The condition embedding 318 can be provided at a cross-attention layer of the cross-attention downsampling blocks 310 and the cross-attention up-sampling block 314.

The machine learning system 300 is illustrated as receiving a time embedding 324. The time embedding 324 can be a value representing an iteration of diffusion process for training the machine learning system 300. For example, the machine learning system can add 3D noise (e.g., additional ellipsoids) to a ground truth 3D Gaussian splat representation of an object based on the condition embedding 318 (e.g., an object represent in the image 306 from the requested viewing angle of the viewing angle information 308). The time embedding 324 can be associated with an amount of 3D noise added to the ground truth 3D Gaussian splat representation (e.g., more 3D noise can be added each iteration). The output of the machine learning system 300 (e.g., the 3D Gaussian splat representation 312) can be compared to the ground truth 3D Gaussian splat representation to determine a loss of the machine learning system 300. The machine learning system 300 can adjust parameters of cross-attention layers, parameters of normalization layers of the machine learning system 300, parameters of convolutional layers of the machine learning system 300, and parameters of additional layers of the machine learning system 300 to reduce the loss of a loss function of the machine learning system 300.

FIG. 4 is a block diagram illustrating an example training process of training a machine learning system 400. For example, the machine learning system 400 can be the machine learning system 300 of FIG. 3, the machine learning system 200 of FIG. 2, or the machine learning model 202 of FIG. 2.

The machine learning system 300 can iteratively add noise to a ground truth 3D Gaussian splat representation 410. The ground truth 3D Gaussian splat representation 410 with added 3D noise can be illustrated as noisy 3D Gaussian splat 404-1, noisy 3D Gaussian splat 404-2, and noisy 3D Gaussian splat 404-3. Each noisy 3D Gaussian splat can be associated with an iteration of the training process. The amount of 3D noise added with each iteration of the training process can be cumulative. For example, each subsequent iteration of the training process can add additional 3D noise to the ground truth 3D Gaussian splat representation 410. In such an example, noisy 3D Gaussian splat 404-2 can include more 3D noise than previous iterations such as noisy 3D Gaussian splat 404-1. The noisy 3D Gaussian splat 404-1, 404-2, and 404-3 can be represented as zₜ=αₜz₀+σₜ∈ where zₜ represents a noisy 3D Gaussian splat representation including an amount of 3D noise based on an iteration of the training process (t). The ground truth 3D Gaussian splat representation 410 can be represented as z₀. In such an example, at and σₜ∈ can represent noise added to the ground truth 3D Gaussian splat representation 410 to generate zₜ.

The training process can include providing the noisy 3D Gaussian splat 404-1, 404-2, and 404-3 iteratively to a machine learning model 402 (e.g., the machine learning model 202 of FIG. 2 or the machine learning system 300 of FIG. 3). The machine learning model 402 can receive a noisy Gaussian splat (such as one of noisy 3D Gaussian splat 404-1, 404-2, and 404-3) and conditional inputs (e.g., image 406 and user prompt 408) associated with the ground truth 3D Gaussian splat representation 410. For example, the ground truth 3D Gaussian splat representation 410 can be a ground truth based on the conditional inputs (e.g., a 3D Gaussian splat of an object represented in the image 406 at a viewing angle requested in the user prompt 408).

The machine learning model can process the noisy 3D Gaussian splat 404-1, 404-2, and 404-3 and the conditional inputs to generate a 3D Gaussian splat representation based on the conditional inputs. The 3D Gaussian splat representation can be compared to the ground truth 3D Gaussian splat representation 410 to determine a loss between the ground truth and the output of the machine learning model 402. The training process can include adjusting the machine learning model 402 (such as by adjusting parameters of a cross-attention layer or parameters of a normalization layer of the machine learning model 402) to reduce a loss function.

In some aspects, training of one or more of the machine learning systems or neural networks described herein (e.g., such as the machine learning systems of FIGS. 2-4, among various other machine learning networks and models described herein) can be performed using online training (e.g., in some case on-device training), offline training, and/or various combinations of online and offline training. In some cases, online can refer to time periods during which the input data (e.g., such as the sensor data, images, masks) is processed, for example for performance of optimizing loss weights of the loss function to reduce losses while maintaining accuracy of the neural network. In some examples, offline can refer to idle time periods or time periods during which input data is not being processed. Additionally, offline can be based on one or more time conditions (e.g., after a particular amount of time has expired, such as a day, a week, a month, etc.) and/or can be based on various other conditions such as network and/or server availability, etc., among various others. In some aspects, offline training of a machine learning model (e.g., a neural network model) can be performed by a first device (e.g., a server device) to generate a pre-trained model, and a second device can receive the trained model from the second device. In some cases, the second device (e.g., a mobile device, an XR device, a vehicle or system/component of the vehicle, or other device) can perform online (or on-device) training of the pre-trained model to further adapt or tune the parameters of the model.

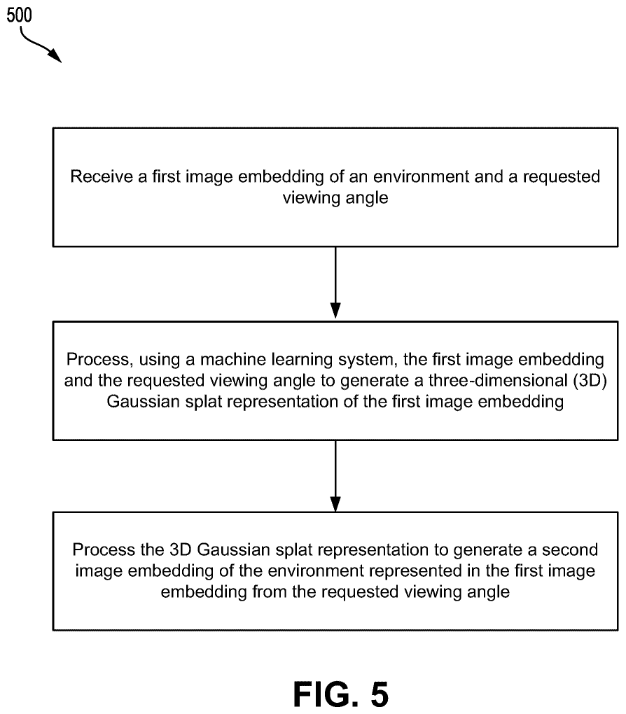

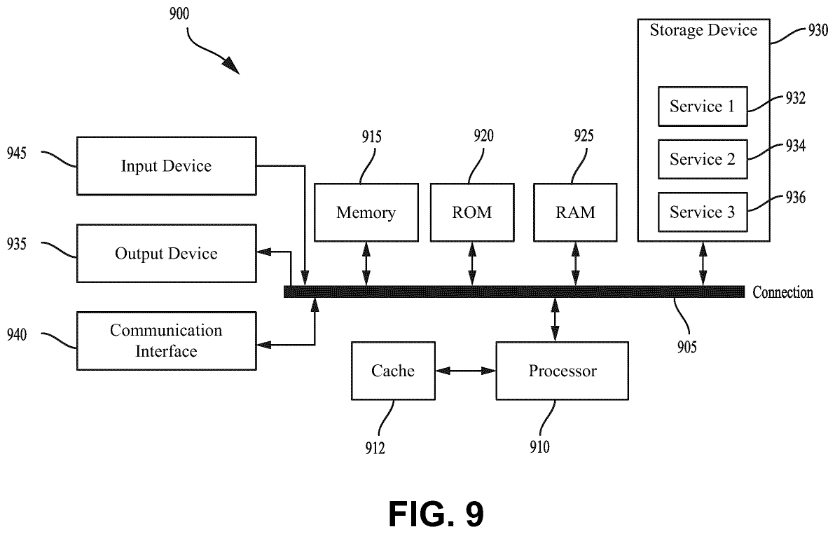

FIG. 5 is a flow diagram illustrating an example process 500 for machine learning processing. The process 500 can be performed by a computing device (e.g., SOC 100 of FIG. 1, computing device or computing system 900 of FIG. 9, etc.) or by a component or system (e.g., the machine learning system 200 of FIG. 2, the machine learning system 300 of FIG. 3, the machine learning system 400 of FIG. 4, etc.), a chipset, one or more processors central processing units (CPUs), digital signal processors (DSPs), graphics processing units (GPUs), any other type of processor(s), any combination thereof, or other component or system) of the computing device. The operations of the process 500 can be implemented as software components that are executed and run on one or more processors (e.g., processor 910 of FIG. 9 or other processor(s)) of the computing device. Further, the transmission and reception of signals by the computing device in the process 500 can be enabled, for example, by one or more antennas, one or more microphones, and/or one or more transceivers (e.g., wireless transceiver(s)).

At block 502, the computing device (or component thereof) can receive a first image embedding of an environment and a requested viewing angle. In some aspects, the first image embedding of the object can be associated with an embedding representation of a plurality of images of an object in the environment. In such an example, the plurality of images can be images of the object in the environment (or of the environment) from differing viewing angles and viewing locations (e.g., locations within the environment). In such an example, the image embedding can include information associated with a first image from a first viewing angle (e.g., a first perspective of an object or environment) and a second image from a second viewing angle (e.g., a first perspective of an object or environment). In some examples, the computing device (or component thereof) can include an image sensor to generate an image of the environment. In such an example, the computing device (or component thereof) can generate the first image embedding from an image generated using the image sensor.

In some examples, requested viewing angle can be an embedding representation of a pixel-by-pixel position and orientation of the requested viewing angle of an object (or the environment) represented in the image embedding. For example, the viewing angle can be determined from on the embedding representation based on a shift in pixel-by-pixel position and orientation from the first image embedding and the embedding representation of the requested viewing angle. In further examples, the requested viewing angle can be determined based on user input. For example, the user input can be

At block 504, the computing device (or component thereof) can process the first image embedding and the requested viewing angle to generate a 3D Gaussian splat representation of the first image embedding. For example, the computing device (or component thereof) can use a machine learning system to process the first image embedding and the requested viewing angle. In some examples, the machine learning system can include a diffusion model. In such an example, the diffusion model can use or include U-Net convolutional neural network architecture, such as a 3D U-Net. For example, the machine learning system can be the machine learning system 300 of FIG. 3.

In an example where the machine learning system includes a diffusion model (e.g., a diffusion machine learning model), the computing device (or component thereof) can process the first image embedding, the requested viewing angle, and a 3D Gaussian splat noise distribution. In some examples, the 3D Gaussian splat noise distribution can be a random noise distribution of 3D Gaussian splats. For example, the random distribution can be a Gaussian distribution.

In some examples, the 3D Gaussian splat representation can include a plurality of ellipsoids (such as 3D ellipsoids) arranged in an estimated 3D shape of an object (or the environment) represented in the first image embedding. In some examples, the 3D Gaussian splat representation can be arranged from the requested viewing angle. In another example, the

At block 506, the computing device (or component thereof) can process the 3D Gaussian splat representation to generate a second image embedding of the environment represented in the first image embedding from the requested viewing angle. In some examples, the computing device can process the 3D Gaussian splat representation using a renderer (such as the rendering engine 212 of FIG. 2). For example, the renderer can render an image (represented as the second image embedding) of the environment or object in the environment from the requested viewing angle. In further examples, the computing device can generate 3D mesh representations of the environment or an object in the environment. For example, the computing device (or component thereof) can process, using a decoder, the 3D Gaussian splat representation to generate a 3D mesh representation of the environment. In such an example, the decoder can be a decoder of the machine learning system 200 of FIG. 2, machine learning system 300 of FIG. 3, or the machine learning system 400 of FIG. 4. In another example, the computing device (or component thereof) can process, using a decoder, the 3D Gaussian splat representation to generate a 3D mesh representation of an object represented in the first image embedding.

In some examples, the machine learning system can be trained using on-device training. In further examples, the machine learning system can be trained on another device, such as a server or edge device, and the trained machine learning system can be deployed to the computing device. In one example, the on-device training can be performed by processing training data using the machine learning system to reduce a loss function. In such an example, the training data can include a first plurality of 3D Gaussian splat representations of a training object with varying amounts of noise and a training image embedding of the training object. In such an example, the training image embedding of the training object can be used as a ground truth to which the output of the machine learning system is compared. The machine learning system can process the training data to generate a second plurality of 3D Gaussian splat representations of the training object. In some examples, the machine learning system can determine a loss based on a comparison of the second plurality of 3D Gaussian splat representations to a ground truth 3D Gaussian splat representation. In further examples, the computing device (or component thereof) can adjust parameters of the machine learning system based on the loss. In some examples, the adjustment of the parameters of the machine learning system includes at least one of adjustment of parameters of a normalization layer of the machine learning system or adjustment of parameters of a cross-attention layer of the machine learning system.

FIG. 6 is an illustrative example of a deep learning neural network 600 that can be used by the machine learning system 200. An input layer 620 includes input data. In one illustrative example, the input layer 620 can include data representing the pixels of an input image or video frame. The neural network 600 includes multiple hidden layers 622a, 622b, through 622n. The hidden layers 622a, 622b, through 622n include “n” number of hidden layers, where “n” is an integer greater than or equal to one. The number of hidden layers can be made to include as many layers as needed for the given application. The neural network 600 further includes an output layer 624 that provides an output resulting from the processing performed by the hidden layers 622a, 622b, through 622n. In one illustrative example, the output layer 624 can provide a classification for an object in an input image or video frame. The classification can include a class identifying the type of object (e.g., a static object, a vehicle, a person, a dog, a cat, or other object).

The neural network 600 is a multi-layer neural network of interconnected nodes. Each node can represent a piece of information. Information associated with the nodes is shared among the different layers and each layer retains information as information is processed. In some cases, the neural network 600 can include a feed-forward network, in which case there are no feedback connections where outputs of the network are fed back into itself. In some cases, the neural network 600 can include a recurrent neural network, which can have loops that allow information to be carried across nodes while reading in input.

Information can be exchanged between nodes through node-to-node interconnections between the various layers. Nodes of the input layer 620 can activate a set of nodes in the first hidden layer 622a. For example, as shown, each of the input nodes of the input layer 620 is connected to each of the nodes of the first hidden layer 622a. The nodes of the hidden layers 622a, 622b, through 622n can transform the information of each input node by applying activation functions to the information. The information derived from the transformation can then be passed to and can activate the nodes of the next hidden layer 622b, which can perform their own designated functions. Example functions include convolutional, up-sampling, data transformation, and/or any other suitable functions. The output of the hidden layer 622b can then activate nodes of the next hidden layer, and so on. The output of the last hidden layer 622n can activate one or more nodes of the output layer 624, at which an output is provided. In some cases, while nodes (e.g., node 626) in the neural network 600 are shown as having multiple output lines, a node has a single output and all lines shown as being output from a node represent the same output value.

In some cases, each node or interconnection between nodes can have a weight that is a set of parameters derived from the training of the neural network 600. Once the neural network 600 is trained, it can be referred to as a trained neural network, which can be used to classify one or more objects. For example, an interconnection between nodes can represent a piece of information learned about the interconnected nodes. The interconnection can have a tunable numeric weight that can be tuned (e.g., based on a training dataset), allowing the neural network 600 to be adaptive to inputs and able to learn as more and more data is processed.

The neural network 600 is pre-trained to process the features from the data in the input layer 620 using the different hidden layers 622a, 622b, through 622n in order to provide the output through the output layer 624. In an example in which the neural network 600 is used to identify objects in images, the neural network 600 can be trained using training data that includes both images and labels. For instance, training images can be input into the network, with each training image having a label indicating the classes of the one or more objects in each image (basically, indicating to the network what the objects are and what features they have). In one illustrative example, a training image can include an image of a number 2, in which case the label for the image can be [0 0 1 0 0 0 0 0 0 0].

In some cases, the neural network 600 can adjust the weights of the nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training images until the neural network 600 is trained well enough so that the weights of the layers are accurately tuned.

For the example of identifying objects in images, the forward pass can include passing a training image through the neural network 600. The weights are initially randomized before the neural network 600 is trained. The image can include, for example, an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

For a first training iteration for the neural network 600, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 600 is unable to determine low level features and thus cannot make an accurate determination of what the classification of the object might be. A loss function can be used to analyze error in the output. Any suitable loss function definition can be used. One example of a loss function includes a mean squared error (MSE). The MSE is defined as

$${E}_{total} = \sum \frac{1}{2} {( target - output )}^{2} ,$$

which calculates the sum of one-half times the actual answer minus the predicted (output) answer squared. The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. The neural network 600 can perform a backward pass by determining which inputs (weights) most contributed to the loss of the network and can adjust the weights so that the loss decreases and is eventually minimized.

A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{dL}{dW} ,$$

where w denotes a weight, wᵢ denotes the initial weight, and η denotes a learning rate. The learning rate can be set to any suitable value, with a high learning rate including larger weight updates and a lower value indicating smaller weight updates.

The neural network 600 can include any suitable deep network. One example includes a convolutional neural network (CNN), which includes an input layer and an output layer, with multiple hidden layers between the input and out layers. An example of a CNN is described below with respect to FIG. 6. The hidden layers of a CNN include a series of convolutional, nonlinear, pooling (for downsampling), and fully connected layers. The neural network 600 can include any other deep network other than a CNN, such as an autoencoder, a deep belief nets (DBNs), a Recurrent Neural Networks (RNNs), among others.

FIG. 7 is an illustrative example of a convolutional neural network 700 (CNN 700). The input layer 720 of the CNN 700 includes data representing an image. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 722a, an optional non-linear activation layer, a pooling hidden layer 722b, and fully connected hidden layers 722c to get an output at the output layer 724. While only one of each hidden layer is shown in FIG. 7, one of ordinary skill will appreciate that multiple convolutional hidden layers, non-linear layers, pooling hidden layers, and/or fully connected layers can be included in the CNN 700. As previously described, the output can indicate a single class of an object or can include a probability of classes that best describe the object in the image.

The first layer of the CNN 700 is the convolutional hidden layer 722a. The convolutional hidden layer 722a analyzes the image data of the input layer 720. Each node of the convolutional hidden layer 722a is connected to a region of nodes (pixels) of the input image called a receptive field. The convolutional hidden layer 722a can be considered as one or more filters (each filter corresponding to a different activation or feature map), with each convolutional iteration of a filter being a node or neuron of the convolutional hidden layer 722a. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 722a. Each connection between a node and a receptive field for that node learns a weight and, in some cases, an overall bias such that each node learns to analyze its particular local receptive field in the input image. Each node of the hidden layer 722a will have the same weights and bias (called a shared weight and a shared bias). For example, the filter has an array of weights (numbers) and the same depth as the input. A filter will have a depth of 3 for the image or video frame example (according to three color components of the input image). An illustrative example size of the filter array is 5×5×3, corresponding to a size of the receptive field of a node.

The convolutional nature of the convolutional hidden layer 722a is due to each node of the convolutional layer being applied to its corresponding receptive field. For example, a filter of the convolutional hidden layer 722a can begin in the top-left corner of the input image array and can convolve around the input image. As noted above, each convolutional iteration of the filter can be considered a node or neuron of the convolutional hidden layer 722a. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 722a. For example, a filter can be moved by a step amount to the next receptive field. The step amount can be set to 1 or other suitable amount. For example, if the step amount is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 722a.

The mapping from the input layer to the convolutional hidden layer 722a is referred to as an activation map (or feature map). The activation map includes a value for each node representing the filter results at each locations of the input volume. The activation map can include an array that includes the various total sum values resulting from each iteration of the filter on the input volume. For example, the activation map will include a 24×24 array if a 5×5 filter is applied to each pixel (a step amount of 1) of a 28×28 input image. The convolutional hidden layer 722a can include several activation maps in order to identify multiple features in an image. The example shown in FIG. 7 includes three activation maps. Using three activation maps, the convolutional hidden layer 722a can detect three different kinds of features, with each feature being detectable across the entire image.

In some examples, a non-linear hidden layer can be applied after the convolutional hidden layer 722a. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 700 without affecting the receptive fields of the convolutional hidden layer 722a.

The pooling hidden layer 722b can be applied after the convolutional hidden layer 722a (and after the non-linear hidden layer when used). The pooling hidden layer 722b is used to simplify the information in the output from the convolutional hidden layer 722a. For example, the pooling hidden layer 722b can take each activation map output from the convolutional hidden layer 722a and generates a condensed activation map (or feature map) using a pooling function. Max-pooling is one example of a function performed by a pooling hidden layer. Other forms of pooling functions be used by the pooling hidden layer 722a, such as average pooling, L2-norm pooling, or other suitable pooling functions. A pooling function (e.g., a max-pooling filter, an L2-norm filter, or other suitable pooling filter) is applied to each activation map included in the convolutional hidden layer 722a. In the example shown in FIG. 7, three pooling filters are used for the three activation maps in the convolutional hidden layer 722a.

In some examples, max-pooling can be used by applying a max-pooling filter (e.g., having a size of 2×2) with a step amount (e.g., equal to a dimension of the filter, such as a step amount of 2) to an activation map output from the convolutional hidden layer 722a. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 722a having a dimension of 24×24 nodes, the output from the pooling hidden layer 722b will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

Intuitively, the pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 700.

The final layer of connections in the network is a fully-connected layer that connects every node from the pooling hidden layer 722b to every one of the output nodes in the output layer 724. Using the example above, the input layer includes 28×28 nodes encoding the pixel intensities of the input image, the convolutional hidden layer 722a includes 3×24×24 hidden feature nodes based on application of a 5×5 local receptive field (for the filters) to three activation maps, and the pooling layer 722b includes a layer of 3×12×12 hidden feature nodes based on application of max-pooling filter to 2×2 regions across each of the three feature maps. Extending this example, the output layer 724 can include ten output nodes. In such an example, every node of the 3×12×12 pooling hidden layer 722b is connected to every node of the output layer 724.

The fully connected layer 722c can obtain the output of the previous pooling layer 722b (which should represent the activation maps of high-level features) and determines the features that most correlate to a particular class. For example, the fully connected layer 722c layer can determine the high-level features that most strongly correlate to a particular class and can include weights (nodes) for the high-level features. A product can be computed between the weights of the fully connected layer 722c and the pooling hidden layer 722b to obtain probabilities for the different classes. For example, if the CNN 700 is being used to predict that an object in an image or video frame is a vehicle, high values will be present in the activation maps that represent high-level features of vehicles (e.g., two or four tires, a windshield, side view mirrors, etc.).

In some examples, the output from the output layer 724 can include an M-dimensional vector (in the prior example, M=10), where M can include the number of classes that the program has to choose from when classifying the object in the image. Other example outputs can also be provided. Each number in the N-dimensional vector can represent the probability the object is of a certain class. In one illustrative example, if a 10-dimensional output vector represents ten different classes of objects is [0 0 0.05 0.8 0 0.9 0 0 0 0], the vector indicates that there is a 5% probability that the image is the third class of object (e.g., a person), an 80% probability that the image is the fourth class of object (e.g., a static object on a road or other driving surface), and a 9% probability that the image is the sixth class of object (e.g., a vehicle). The probability for a class can be considered a confidence level that the object is part of that class.

FIG. 8 is a block diagram of an example transformer in accordance with some aspects of the disclosure.

In a convolutional neural network (CNN) model, the number of operations required to relate signals from two arbitrary input or output positions grows in the distance between positions, which makes learning dependencies at different distant positions challenging for a CNN model. A transformer 800 reduces the operations of learning dependencies by using an encoder 810 and a decoder 830 that implement an attention mechanism at different positions of a single sequence to compute a representation of that sequence. An attention function can be described as mapping a query and a set of key-value pairs to an output, where the query, keys, values, and output are all vectors. The output is computed as a weighted sum of the values, where the weight assigned to each value is computed by a compatibility function of the query with the corresponding key.

In one example of a transformer, the encoder 810 is composed of a stack of six identical layers and each layer has two sub-layers. The first sub-layer is a multi-head self-attention engine 812, and the second sub-layer is a fully connected feed-forward network 814. A residual connection (not shown) connects around each of the sub-layers followed by normalization.

In this example transformer 800, the decoder 830 is also composed of a stack of six 6 identical layers. The decoder also includes a masked multi-head self-attention engine 832, a multi-head attention engine 834 over the output of the encoder 810, and a fully connected feed-forward network 826. Each layer includes a residual connection (not shown) around the layer, which is followed by layer normalization. The masked multi-head self-attention engine 832 is masked to prevent positions from attending to subsequent positions and ensures that the predictions at position i can depend only on the known outputs at positions less than i (e.g., auto-regression).

In the transformer, the queries, keys, and values are linearly projected by a multi-head attention engine into learned linear projects, and then attention is performed in parallel on each of the learned linear projects, which are concatenated and then projected into final values.

The transformer also includes a positional encoder 840 to encode positions because the model does not contain recurrence and convolution, and relative or absolute position of the tokens is needed. In the transformer 800, the positional encodings are added to the input embeddings at the bottom layer of the encoder 810 and the decoder 830. The positional encodings are summed with the embeddings because the positional encodings and embeddings have the same dimensions. A corresponding position decoder 850 is configured to decode the positions of the embeddings for the decoder 830.

In some aspects, the transformer 800 uses self-attention mechanisms to selectively weigh the importance of different parts of an input sequence during processing and allows the model to attend to different parts of the input sequence while generating the output. The input sequence is first embedded into vectors and then passed through multiple layers of self-attention and feed-forward networks. The transformer 800 can process input sequences of variable length, making it well-suited for natural language processing tasks where input lengths can vary greatly. Additionally, the self-attention mechanism allows the transformer 800 to capture long-range dependencies between words in the input sequence, which is difficult for RNNs and CNNs. The transformer with self-attention has achieved results in several natural language processing tasks that are beyond the capabilities of other neural networks and has become a popular choice for language and text applications. For example, the various large language models, such as a generative pretrained transformer (e.g., ChatGPT, etc.) and other current models are types of transformer networks.

FIG. 9 illustrates an example computing system 900 of an example computing device which can implement the various techniques described herein. For example, the computing system 900 can implement the machine learning system 200 shown in FIG. 2. The components of computing system 900 are shown in electrical communication with each other using connection 905, such as a bus. The example computing system 900 includes a processing unit (CPU or processor) 910 and computing device connection 905 that couples various computing device components including computing device memory 915, such as read only memory (ROM) 920 and random access memory (RAM) 925, to processor 910.

Computing system 900 can include a cache of high-speed memory connected directly with, in close proximity to, or integrated as part of processor 910. Computing system 900 can copy data from memory 915 and/or the storage device 930 to cache 912 for quick access by processor 910. In this way, the cache can provide a performance boost that avoids processor 910 delays while waiting for data. These and other modules can control or be configured to control processor 910 to perform various actions. Other computing device memory 915 may be available for use as well. Memory 915 can include multiple different types of memory with different performance characteristics. Processor 910 can include any general purpose processor and a hardware or software service, such as service 1 932, service 2 934, and service 3 936 stored in storage device 930, configured to control processor 910 as well as a special-purpose processor where software instructions are incorporated into the processor design. Processor 910 may be a self-contained system, containing multiple cores or processors, a bus, memory controller, cache, etc. A multi-core processor may be symmetric or asymmetric.

To enable user interaction with the computing system 900, input device 945 can represent any number of input mechanisms, such as a microphone for speech, a touch-sensitive screen for gesture or graphical input, keyboard, mouse, motion input, speech and so forth. Output device 935 can also be one or more of a number of output mechanisms known to those of skill in the art, such as a display, projector, television, speaker device, etc. In some instances, multimodal computing devices can enable a user to provide multiple types of input to communicate with computing system 900. Communication interface 940 can generally govern and manage the user input and computing device output. There is no restriction on operating on any particular hardware arrangement and therefore the basic features here may easily be substituted for improved hardware or firmware arrangements as they are developed.

Storage device 930 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 925, read only memory (ROM) 920, and hybrids thereof. Storage device 930 can include services 932, 934, 936 for controlling processor 910. Other hardware or software modules are contemplated. Storage device 930 can be connected to the computing device connection 905. In one aspect, a hardware module that performs a particular function can include the software component stored in a computer-readable medium in connection with the necessary hardware components, such as processor 910, connection 905, output device 935, and so forth, to carry out the function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“>”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus for image processing, at least one memory; and at least one processor coupled to the at least one memory and configured to: receive a first image embedding of an environment and a requested viewing angle; process, using a machine learning system, the first image embedding and the requested viewing angle to generate a three-dimensional (3D) Gaussian splat representation of the first image embedding; and process the 3D Gaussian splat representation to generate a second image embedding of the environment represented in the first image embedding from the requested viewing angle.

Aspect 2. The apparatus of Aspect 1, wherein the at least one processor is configured to: process, using a decoder, the 3D Gaussian splat representation to generate a 3D mesh representation of the environment.

Aspect 3. The apparatus of any of Aspects 1 to 2, wherein the at least one processor is configured to: process, using a decoder, the 3D Gaussian splat representation to generate a 3D mesh representation of an object represented in the first image embedding.

Aspect 4. The apparatus of any of Aspects 1 to 3, wherein to generate the 3D Gaussian splat representation of the environment, the at least one processor is configured to process, using the machine learning system, the first image embedding, the requested viewing angle, and a 3D Gaussian splat noise distribution.

Aspect 5. The apparatus of any of Aspects 1 to 4, wherein the 3D Gaussian splat noise distribution is a random noise distribution of 3D Gaussian splats.

Aspect 6. The apparatus of any of Aspects 1 to 5, wherein the first image embedding is associated with an embedding representation of a plurality of images of the environment.

Aspect 7. The apparatus of any of Aspects 1 to 6, wherein the 3D Gaussian splat representation includes a plurality of 3D ellipsoids arranged in an estimated 3D shape of an object represented in the first image embedding from the requested viewing angle.

Aspect 8. The apparatus of any of Aspects 1 to 7, wherein the requested viewing angle is an embedding representation of a pixel-by-pixel position and orientation of the requested viewing angle of an object represented in the first image embedding.

Aspect 9. The apparatus of any of Aspects 1 to 8, wherein the requested viewing angle is determined based on a user input.

Aspect 10. The apparatus of any of Aspects 1 to 9, wherein the machine learning system is trained using on-device training.

Aspect 11. The apparatus of any of Aspects 1 to 10, wherein to perform the on-device training, the at least one processor is configured to: process, using the machine learning system, training data including a first plurality of 3D Gaussian splat representations of a training object with varying amounts of noise and a training image embedding of the training object, to generate a second plurality of 3D Gaussian splat representations of the training object; determine a loss based on a comparison of the second plurality of 3D Gaussian splat representations to a ground truth 3D Gaussian splat representation; and adjust parameters of the machine learning system based on the loss.

Aspect 12. The apparatus of any of Aspects 1 to 11, wherein adjustment of the parameters of the machine learning system includes at least one of adjustment of parameters of a normalization layer of the machine learning system or adjustment of parameters of a cross-attention layer of the machine learning system.

Aspect 13. The apparatus of any of Aspects 1 to 12, wherein the machine learning system includes a diffusion machine learning model, the diffusion machine learning model using a U-Net convolutional neural network (CNN) architecture.

Aspect 14. A method comprising: receiving a first image embedding of an environment and a requested viewing angle; processing, using a machine learning system, the first image embedding and the requested viewing angle to generate a three-dimensional (3D) Gaussian splat representation of the first image embedding; and processing the 3D Gaussian splat representation to generate a second image embedding of the environment represented in the first image embedding from the requested viewing angle.

Aspect 15. The method of Aspect 14, further comprising: processing, using a decoder, the 3D Gaussian splat representation to generate a 3D mesh representation of the environment.

Aspect 16. The method of any of Aspects 14 to 15, further comprising: processing, using a decoder, the 3D Gaussian splat representation to generate a 3D mesh representation of an object represented in the first image embedding.

Aspect 17. The method of any of Aspects 14 to 16, wherein to generate the 3D Gaussian splat representation of the environment, the process further comprises: processing, using the machine learning system, the first image embedding, the requested viewing angle, and a 3D Gaussian splat noise distribution.

Aspect 18. The method of any of Aspects 14 to 17, wherein the 3D Gaussian splat noise distribution is a random noise distribution of 3D Gaussian splats.

Aspect 19. The method of any of Aspects 14 to 18, wherein the first image embedding is associated with an embedding representation of a plurality of images of the environment.

Aspect 20. The method of any of Aspects 14 to 19, wherein the 3D Gaussian splat representation includes a plurality of 3D ellipsoids arranged in an estimated 3D shape of an object represented in the first image embedding from the requested viewing angle.

Aspect 21. The method of any of Aspects 14 to 20, wherein the requested viewing angle is an embedding representation of a pixel-by-pixel position and orientation of the requested viewing angle of an object represented in the first image embedding.

Aspect 22. The method of any of Aspects 14 to 21, wherein the requested viewing angle is determined based on a user input.

Aspect 23. The method of any of Aspects 14 to 22, wherein the machine learning system is trained using on-device training.

Aspect 24. The method of any of Aspects 14 to 23, the method further comprising: processing, using the machine learning system, training data including a first plurality of 3D Gaussian splat representations of a training object with varying amounts of noise and a training image embedding of the training object, to generate a second plurality of 3D Gaussian splat representations of the training object; determining a loss based on a comparison of the second plurality of 3D Gaussian splat representations to a ground truth 3D Gaussian splat representation; and adjusting parameters of the machine learning system based on the loss.

Aspect 25. The method of any of Aspects 14 to 24, wherein adjustment of the parameters of the machine learning system includes at least one of adjustment of parameters of a normalization layer of the machine learning system or adjustment of parameters of a cross-attention layer of the machine learning system.

Aspect 26. The method of any of Aspects 14 to 25, wherein the machine learning system includes a diffusion machine learning model, the diffusion machine learning model using a U-Net convolutional neural network (CNN) architecture.

Aspect 27. A non-transitory computer-readable medium having stored thereon instructions that, when executed by at least one processor, cause the at least one processor to perform one or more of operations according to any of Aspects 14 to 26.

Aspect 28. An apparatus for image processing comprising one or more means for performing operations according to any of Aspects 14 to 26.

What is claimed:

1. An apparatus for image processing,
at least one memory; and
at least one processor coupled to the at least one memory and configured to:
receive a first image embedding of an environment and a requested viewing angle;
process, using a machine learning system, the first image embedding and the requested viewing angle to generate a three-dimensional (3D) Gaussian splat representation of the first image embedding; and
process the 3D Gaussian splat representation to generate a second image embedding of the environment represented in the first image embedding from the requested viewing angle.

2. The apparatus of claim 1, wherein the at least one processor is configured to:
process, using a decoder, the 3D Gaussian splat representation to generate a 3D mesh representation of the environment.

3. The apparatus of claim 2, wherein the at least one processor is configured to:
process, using a decoder, the 3D Gaussian splat representation to generate a 3D mesh representation of an object represented in the first image embedding.

4. The apparatus of claim 1, wherein to generate the 3D Gaussian splat representation of the environment, the at least one processor is configured to process, using the machine learning system, the first image embedding, the requested viewing angle, and a 3D Gaussian splat noise distribution.

5. The apparatus of claim 4, wherein the 3D Gaussian splat noise distribution is a random noise distribution of 3D Gaussian splats.

6. The apparatus of claim 1, wherein the first image embedding is associated with an embedding representation of a plurality of images of the environment.

7. The apparatus of claim 1, wherein the 3D Gaussian splat representation includes a plurality of 3D ellipsoids arranged in an estimated 3D shape of an object represented in the first image embedding from the requested viewing angle.

8. The apparatus of claim 1, wherein the requested viewing angle is an embedding representation of a pixel-by-pixel position and orientation of the requested viewing angle of an object represented in the first image embedding.

9. The apparatus of claim 1, wherein the requested viewing angle is determined based on a user input.

10. The apparatus of claim 1, wherein the machine learning system includes a diffusion machine learning model, the diffusion machine learning model using a U-Net convolutional neural network (CNN) architecture.

11. A method comprising:
receiving a first image embedding of an environment and a requested viewing angle;
processing, using a machine learning system, the first image embedding and the requested viewing angle to generate a three-dimensional (3D) Gaussian splat representation of the first image embedding; and
processing the 3D Gaussian splat representation to generate a second image embedding of the environment represented in the first image embedding from the requested viewing angle.

12. The method of claim 11, further comprising:
processing, using a decoder, the 3D Gaussian splat representation to generate a 3D mesh representation of the environment.

13. The method of claim 11, further comprising:
processing, using a decoder, the 3D Gaussian splat representation to generate a 3D mesh representation of an object represented in the first image embedding.

14. The method of claim 11, wherein to generate the 3D Gaussian splat representation of the environment, the method further comprises using the machine learning system, the first image embedding, the requested viewing angle, and a 3D Gaussian splat noise distribution.

15. The method of claim 14, wherein the 3D Gaussian splat noise distribution is a random noise distribution of 3D Gaussian splats.

16. The method of claim 11, wherein the first image embedding is associated with an embedding representation of a plurality of images of the environment.

17. The method of claim 11, wherein the 3D Gaussian splat representation includes a plurality of 3D ellipsoids arranged in an estimated 3D shape of an object represented in the first image embedding from the requested viewing angle.

18. The method of claim 11, wherein the requested viewing angle is an embedding representation of a pixel-by-pixel position and orientation of the requested viewing angle of an object represented in the first image embedding.

19. The method of claim 11, wherein the requested viewing angle is determined based on a user input.

20. A non-transitory computer-readable medium having stored thereon instructions that, when executed by at least one processor, cause the at least one processor to:
receive a first image embedding of an environment and a requested viewing angle;
process, using a machine learning system, the first image embedding and the requested viewing angle to generate a three-dimensional (3D) Gaussian splat representation of the first image embedding; and
process the 3D Gaussian splat representation to generate a second image embedding of the environment represented in the first image embedding from the requested viewing angle.
